(19) United States
(12) Patent Application Publication
(10) Pub. No.: US 2024/0052200 A1
(43) Pub. Date: Feb. 15, 2024

(54) HEMP OIL-BASED PAINT COMPOSITIONS AND METHODS OF MANUFACTURE THEREOF

(71) Applicant: Anong Beam, M'Chigeeng (CA)

(72) Inventor: Anong Beam, M'Chigeeng (CA)

(21) Appl. No.: 17/883,649

(22) Filed: Aug. 9, 2022

(51) Int. Cl. C09D 191/00; C09D 7/61; C09D 7/45; C09D 7/80

(52) U.S. Cl. CPC C09D 191/00; C09D 7/61; C09D 7/45; C09D 7/80

(57) ABSTRACT

The present specification relates generally to paint compositions and more specifically to hemp oil-based paint compositions and methods for preparing same. The hemp oil-based paint compositions apply smoothly and easily, are fast-drying, and deliver a uniform, opaque coat, but are non-toxic, VOC free and fume free. Consequently, the hemp oil-based paint compositions may reduce health risks and environmental risks and impacts associated with the use of traditional house paints. In a first embodiment, hemp oil-based paint composition comprises a quantity of hemp oil; a quantity of metallic paint drier; a quantity of pigment; and a quantity of limestone. In a second embodiment, hemp oil-based paint composition comprises a quantity of hemp oil; a quantity of metallic paint drier; a quantity of pigment; a quantity of non-ionic emulsifier; a quantity of anionic or non-ionic surfactant; a quantity of thickener; and a quantity of water.

### FIELD OF THE INVENTION

The present specification relates generally to paint compositions and more specifically to hemp-oil based paint compositions and methods for preparing same.

### BACKGROUND OF THE INVENTION

Currently available paints are resin-based, and generally comprise at least one of a number of synthetic compounds including acrylic, epoxy, polyester, polyurethane, vinyl or polyvinylidene fluoride. These compounds are sources of volatile organic compounds (“VOCs”) which are known to off-gas into the air we breathe, rendering them particularly dangerous in the context of paints for interior use (e.g., house paints). Inhaling VOCs is known to cause eye, nose and throat irritation, may cause difficulty breathing and nausea, and may even damage organs. Certain VOCs may cause cancer.

To mitigate the effects of VOCs, individuals applying paint to building interiors often open windows and doors to increase airflow and reduce the concentration of VOCs in the air within the building. While increasing airflow may reduce the concentration of the VOCs from the paint in the air, it does not reduce that concentration to zero. Painters, visitors, passers-by and other individuals in the building therefore continue to be exposed to these compounds. Parents of young children and individuals suffering from respiratory disorders, in particular, may therefore avoid painting and exposure to fresh paint altogether. Further, opening windows and doors is not always possible or desirable, for example, in the cold winter months when opening windows and doors may cool the building to the point of discomfort and increases the cost of heating the building. Opening windows and doors can also result in dust and debris being blown into the building by the wind and becoming lodged in the fresh coat of paint. This results in an imperfect finish and may create work for the individual painting who may need to remove the debris and subsequently correct the paint application.

In addition to their impact on human health, VOCs pose an environmental threat. In the presence of sunlight, VOCs react with other compounds to form tropospheric ozone (i.e., ground-level smog) which may produce disease in plants, inhibit seed production and hinder fertilization.

Although paint manufacturers have started to offer “eco”, “environmentally friendly”, “natural” and/or “plant-based” paints, these paints continue to comprise a large amount of synthetic ingredients, are only plant-based in part, and/or comprise animal products which deter some potential purchasers.

Accordingly, there remains a need for improvements in the art.

### SUMMARY OF THE INVENTION

In a first embodiment of the present invention, there is provided a hemp oil-based paint composition, comprising: a quantity of hemp oil; a quantity of metallic paint drier; a quantity of pigment; and a quantity of limestone.

According to a second embodiment of the present invention, there is provided a hemp oil-based paint composition, comprising: a quantity of hemp oil; a quantity of metallic paint drier; a quantity of pigment; a quantity of non-ionic emulsifier; a quantity of anionic or non-ionic surfactant; a quantity of thickener; and a quantity of water.

According to yet another embodiment of the present invention, there is provided a method of preparing a hemp oil-based paint composition of the first embodiment, the method comprising: adding the quantity of metallic drier to the quantity of hemp oil to produce a first solution; mixing the first solution; heating the first solution; mixing 25% of the first solution with the quantity of pigment and the quantity of limestone to produce a second solution; processing the second solution though a mill to produce a slurry; adding a remaining 75% of the first solution to the slurry to produce a final solution; and mixing the final solution at high speed.

According to a further embodiment of the present invention, there is provided a method of preparing a hemp oil-based paint composition of the second embodiment, the method comprising: adding the quantity of metallic drier to the quantity of hemp oil to produce a first solution; mixing the first solution; heating the first solution; adding the quantity of non-ionic emulsifier and the quantity of anionic or non-ionic surfactant to the first solution to produce a second solution; mixing the second solution; mixing 25% of the quantity of the water with the quantity of pigment to produce a third solution; processing the third solution though a mill to produce a slurry; adding the quantity of thickener and 75% of the quantity of water to the slurry; adding the slurry to the second solution to produce a final solution; and mixing the final solution at high speed.

Other aspects and features according to the present application will become apparent to those ordinarily skilled in the art upon review of the following description of embodiments of the invention.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention.

According to a first and a second embodiment, hemp-oil based paint compositions are provided which may be used in lieu of traditional interior house paints to paint, among other things, walls and ceilings. The hemp oil-based paint compositions have substantially similar characteristics to traditional latex interior paint. The hemp oil-based paint compositions apply smoothly and easily, are fast drying, and deliver a uniform, opaque coat. Unlike latex paint, the hemp oil-based paint compositions are non-toxic, VOC free and fume-free. Accordingly, the hemp oil-based paint compositions may reduce health risks and environmental risks and impacts associated with the use of traditional house paints, may make do-it-yourself painting more accessible to homeowners, and may substantially simplify the task of painting building interiors. Further, the hemp oil-based paint compositions may save energy which might otherwise be wasted in the course of ventilating spaces painted with traditional paints.

According to a first embodiment, there is provided a hemp oil-based paint composition, comprising: a quantity of hemp oil; a quantity of metallic paint drier; a quantity of pigment; and a quantity of limestone. The hemp oil-based paint composition may be used as textile ink or artist's acrylic.

The hemp oil-based paint composition of the first embodiment comprises a quantity of hemp oil. The quantity of hemp oil varies with a volume of the hemp oil-based paint composition. The quantity of hemp oil may correspond to between 16.08% and 31.92% of the volume of the hemp oil-based paint composition. According to an embodiment, the quantity of hemp oil is equal to 50% of the volume of the hemp oil-based paint composition. The quantity of hemp oil may comprise one of refined hemp oil and unrefined hemp oil.

The hemp oil-based paint composition of the first embodiment further comprises a quantity of metallic paint drier. The quantity of metallic paint drier varies with the quantity of hemp oil. The quantity of metallic paint drier may correspond to between 6.98% and 13.86% of the volume of the quantity of hemp oil. According to an embodiment, the quantity of metallic paint drier is equal to 10% of the volume of the quantity of hemp oil. The quantity of metallic paint drier may comprise one or more of an iron-based drier, a cobalt-based drier, a strontium-based drier, a manganese-based drier, a zinc-based drier, a barium-based drier, a cerium-based drier, a lithium-based drier, a bismuth-based drier, and a vanadium-based drier. According to a preferred embodiment, the quantity of metallic paint drier comprises an iron-based drier.

The hemp oil-based paint composition of the first embodiment further comprises a quantity of pigment. The quantity of pigment varies with the quantity of hemp oil. The quantity of pigment may correspond to between 40.2% and 79.8% of the volume of the quantity of hemp oil. According to an embodiment, the quantity of pigment is equal to 60% of the volume of the quantity of hemp oil. The quantity of pigment may comprise one or more of organic pigment and inorganic pigment. According to a preferred embodiment, the quantity of pigment comprises at least titanium dioxide pigment. According to an embodiment, the quantity of pigment comprises titanium dioxide pigment and a second pigment.

The hemp oil-based paint composition of the first embodiment further comprises a quantity of limestone. The quantity of limestone varies with the quantity of hemp oil. The quantity of limestone may correspond between to 20.1% and 39.9% of the volume of the quantity of hemp oil. According to an embodiment, the quantity of limestone is equal to 30% of the volume of the quantity of hemp oil. The quantity of limestone may comprise one or more of dolomitic limestone, chalk, and travertine. According to a preferred embodiment, the quantity of limestone comprises dolomitic limestone.

According to a second embodiment of the present invention, there is provided a hemp oil-based paint composition, comprising: a quantity of hemp oil; a quantity of metallic paint drier; a quantity of pigment; a quantity of non-ionic emulsifier; a quantity of anionic or non-ionic surfactant; a quantity of thickener; and a quantity of water. The hemp oil-based paint composition of the second embodiment may be used as textile ink or artist's acrylic.

The hemp oil-based paint composition of the second embodiment comprises a quantity of hemp oil. The quantity of hemp oil varies with a volume of the hemp oil-based paint composition. The quantity of hemp oil may correspond to between 16.08% and 31.92% of the volume of the hemp oil-based paint composition. According to an embodiment, the quantity of hemp oil is equal to 24% of the volume of the hemp oil-based paint composition. The quantity of hemp oil may comprise at least one of refined hemp oil and unrefined hemp oil.

The hemp oil-based paint composition of the second embodiment further comprises a quantity of metallic paint drier. The quantity of metallic paint drier varies with the quantity of hemp oil. The quantity of metallic paint drier may correspond to between 6.98% and 13.86% of the volume of the quantity of hemp oil. According to an embodiment, the quantity of metallic paint drier is equal to 10.42% of the volume of the quantity of hemp oil. The quantity of metallic paint drier may comprise one or more of an iron-based drier, a cobalt-based drier, a strontium-based drier, a manganese-based drier, a zinc-based drier, a barium-based drier, a cerium-based drier, a lithium-based drier, a bismuth-based drier, and a vanadium-based drier. According to a preferred embodiment, the quantity of metallic paint drier comprises an iron-based drier.

The hemp oil-based paint composition of the second embodiment further comprises a quantity of non-ionic emulsifier. The quantity of non-ionic emulsifier varies with the quantity of hemp oil. The quantity of non-ionic emulsifier may correspond to between 8.34% and 16.63% of the volume of the quantity of hemp oil. According to an embodiment, the quantity of non-ionic emulsifier is equal to 12.5% of the volume of the quantity of hemp oil. The quantity of non-ionic emulsifier may comprise one or more of tara gum, cetearyl olivate, sorbitan olivate and distilled monoglycerides. According to an embodiment, the quantity of non-ionic emulsifier comprises one of cetearyl olivate and sorbitan olivate.

The hemp oil-based paint composition of the second embodiment further comprises a quantity of anionic or non-ionic surfactant. The quantity of anionic or non-ionic surfactant varies with the quantity of hemp oil. The quantity of anionic or non-ionic surfactant may correspond to between 8.34% and 16.63% of the volume of the quantity of hemp oil. According to an embodiment, the quantity of anionic or non-ionic surfactant is equal to 12.5% of the volume of the quantity of hemp oil. According to an embodiment, the quantity of anionic or non-ionic surfactant comprises one or more of ammonium lauryl sulfate, sodium lauryl sulfate, sodium laureth sulfate, sodium myreth sulfate, dioctyl sodium sulfosuccinate, perfluorooctanesulfonate, perfluorobutanesulfonate, alkyl aryl ether phosphate, alkyl ether phosphate, carboxylate salt, alkyl aryl sulphonate, stearic acid, distilled monoglycerides, cetearyl olivate, and sorbitan olivate. According to an embodiment, the quantity of anionic or non-ionic surfactant comprises stearic acid.

The hemp oil-based paint composition of the second embodiment further comprises a quantity of water. The quantity of water varies with the quantity of hemp oil. The quantity of water may correspond to between 83.75% and 221.67% of the volume of the quantity of hemp oil. According to an embodiment, the quantity of water is equal to 166.67% of the volume of the quantity of hemp oil. According to another embodiment, the quantity of water is equal to 125% of the volume of the quantity of hemp oil. The quantity of water may comprise one or more of filtered tap water, unfiltered tap water, distilled water, and mineral water.

The hemp oil-based paint composition of the second embodiment further comprises a quantity of pigment. The quantity of pigment varies with the quantity of hemp oil. The quantity of pigment may correspond to between 69.79% and 138.55% of the volume of the quantity of hemp oil. According to an embodiment, the quantity of pigment is equal to 104.17% of the volume of the quantity of hemp oil. The quantity of pigment may comprise one or more of organic pigment and inorganic pigment. According to a preferred embodiment, the quantity of pigment comprises at least titanium dioxide pigment. According to an embodiment, the quantity of pigment comprises titanium dioxide pigment and a second pigment.

The hemp oil-based paint composition of the second embodiment further comprises a quantity of thickener. The quantity of thickener varies with the quantity of hemp oil. The quantity of thickener may correspond to between 10.42% and 52.08% of the volume of the quantity of hemp oil. According to an embodiment, the quantity of thickener is equal to 10.42% of the volume of the quantity of hemp oil. According to another embodiment, the quantity of thickener is equal to 52.08% of the volume of the quantity of hemp oil. The quantity of thickener may comprise one or more of attapulgite clay, a gum thickener, and a cellulosic thickener. According to a preferred embodiment, the quantity of thickener comprises attapulgite clay.

According to yet another embodiment of the present invention, there is provided a method of preparing the hemp oil-based paint composition of the first embodiment, comprising: adding the quantity of metallic drier to the quantity of hemp oil to produce a first solution; mixing the first solution; heating the first solution; mixing 25% of the first solution with the quantity of pigment and the quantity of limestone to produce a second solution; processing the second solution though a mill to produce a slurry; adding a remaining 75% of the first solution to the slurry to produce a final solution; and mixing the final solution at high speed.

According to an embodiment, the second solution is processed through a three-roll mill. The first solution and final solution may be mixed with a high-shear mixer. The step of mixing 25% of the first solution with the quantity of pigment and the quantity of limestone to produce a second solution may be executed with a high-shear mixer. According to an embodiment, the first solution is heated until homogeneous to the naked eye. According to an embodiment, the quantity of hemp oil corresponds to between 33.5% and 66.5% of the volume of the hemp oil-based paint composition. According to a further embodiment, the quantity of hemp oil is equal to 50% of the volume of the hemp oil-based paint composition. According to an embodiment, the quantity of metallic paint drier corresponds to 10% of the volume of the quantity of hemp oil. The quantity of metallic paint drier may correspond to between 6.7% and 13.3% of the volume of the quantity of hemp oil. According to an embodiment, the quantity of pigment corresponds to between 40.2% and 79.8% of the volume of the quantity of hemp oil. The quantity of pigment may correspond to 60% of the volume of the quantity of hemp oil. According to an embodiment, the quantity of limestone corresponds to 30% of the volume of the quantity of hemp oil. The quantity of limestone may correspond to between 20.1% and 39.9% of the volume of the quantity of hemp oil.

According to an embodiment, there is provided a method of preparing the hemp-oil based paint composition of the second embodiment, comprising: adding the quantity of metallic drier to the quantity of hemp oil to produce a first solution; mixing the first solution; heating the first solution; adding the quantity of non-ionic emulsifier and the quantity of anionic or non-ionic surfactant to the first solution to produce a second solution; mixing the second solution; mixing 25% of the quantity of the water with the quantity of pigment to produce a third solution; processing the third solution though a mill to produce a slurry; adding the quantity of thickener and 75% of the quantity of water to the slurry; adding the slurry to the second solution to produce a final solution; and mixing the final solution at high speed.

According to an embodiment, the third solution is processed through a three-roll mill. The first solution and final solution may be mixed with a high-shear mixer. The first solution, second solution and final solution may be mixed with a high-shear mixer. The step of mixing 25% of the quantity of the water with the quantity of pigment to produce a third solution may be executed with a high-shear mixer. According to an embodiment, the first solution is heated until homogeneous to the naked eye. According to an embodiment, the quantity of hemp oil corresponds to between 16.08% and 31.92% of the volume of the hemp oil-based paint composition; the quantity of metallic paint drier corresponds to between 6.98% and 13.86% of the volume of the quantity of hemp oil; the quantity of non-ionic emulsifier corresponds to between 8.34% and 16.63% of the volume of the quantity of hemp oil; the quantity of anionic or non-ionic surfactant corresponds to between 8.34% and 16.63% of the volume of the quantity of hemp oil; the quantity of water corresponds to between 83.75% and 221.67% of the volume of the quantity of hemp oil; the quantity of pigment corresponds to between 69.79% and 138.55% of the volume of the quantity of hemp oil; and/or the quantity of thickener corresponds to between 10.42% and 52.08% of the volume of the quantity of hemp oil. According to a further embodiment, the quantity of hemp oil corresponds to 24% of the volume of the hemp oil-based paint composition; the quantity of metallic paint drier corresponds to 10.42% of the volume of the quantity of hemp oil; the quantity of non-ionic emulsifier corresponds to 12.5% of the volume of the quantity of hemp oil; the quantity of anionic or non-ionic surfactant corresponds to 12.5% of the volume of the quantity of hemp oil; the quantity of water corresponds to one of 125% and 166.67% of the volume of the quantity of hemp oil; the quantity of pigment corresponds to 104.17% of the volume of the quantity of hemp oil; and/or the quantity of thickener corresponds to one of 10.42% and 52.08% of the volume of the quantity of hemp oil.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. A hemp oil-based paint composition, comprising:
a quantity of hemp oil;
a quantity of metallic paint drier;
a quantity of pigment; and
a quantity of limestone.

2. The composition of claim 1, wherein the quantity of hemp oil corresponds to between 33.5% and 66.5% of the volume of the hemp oil-based paint composition.

3. The composition of claim 1 or claim 2, wherein the quantity of metallic paint drier corresponds to between 6.7% and 13.3% of the volume of the quantity of hemp oil.

4. The composition of claim 1 or claim 2, wherein the quantity of pigment corresponds to between 40.2% and 79.8% of the volume of the quantity of hemp oil.

5. The composition of claim 1 or claim 2, wherein the quantity of limestone corresponds to between 20.1% and 39.9% of the volume of the quantity of hemp oil.

6. A hemp oil-based paint composition, comprising:
a quantity of hemp oil;
a quantity of metallic paint drier;
a quantity of pigment;
a quantity of non-ionic emulsifier;
a quantity of anionic or non-ionic surfactant;
a quantity of thickener; and
a quantity of water.

7. The composition of claim 6, wherein the quantity of hemp oil corresponds to between 16.08% and 31.92% of the volume of the hemp oil-based paint composition.

8. The composition of claim 6 or claim 7, wherein the quantity of metallic paint drier corresponds to between 6.98% and 13.86% of the volume of the quantity of hemp oil.

9. The composition of claim 6 or claim 7, wherein the quantity of pigment corresponds to between 69.79% and 138.55% of the volume of the quantity of hemp oil.

10. The composition of claim 6 or claim 7, wherein the quantity of non-ionic emulsifier corresponds to between 8.34% and 16.63% of the volume of the quantity of hemp oil.

11. The composition of claim 6 or claim 7, wherein the quantity of anionic or non-ionic surfactant corresponds to between 8.34% and 16.63% of the volume of the quantity of hemp oil.

12. The composition of claim 6 or claim 7, wherein the quantity of water corresponds to between 83.75% and 221.67% of the volume of the quantity of hemp oil.

13. The composition of claim 6 or claim 7, wherein the quantity of thickener corresponds to between 10.42% and 52.08% of the volume of the quantity of hemp oil.

14. A method of preparing the composition of claim 1, comprising:
adding the quantity of metallic drier to the quantity of hemp oil to produce a first solution;
mixing the first solution;
heating the first solution;
mixing 25% of the first solution with the quantity of pigment and the quantity of limestone to produce a second solution;
processing the second solution though a mill to produce a slurry;
adding a remaining 75% of the first solution to the slurry to produce a final solution; and
mixing the final solution at high speed.

15. The method of claim 14, wherein the quantity of hemp oil corresponds to between 33.5% and 66.5% of the volume of the hemp oil-based paint composition.

16. The method of claim 14 or claim 15, wherein the quantity of pigment corresponds to between 40.2% and 79.8% of the volume of the quantity of hemp oil.

17. The method of claim 14 or claim 15, wherein the quantity of metallic paint drier corresponds to between 6.7% and 13.3% of the volume of the quantity of hemp oil.

18. The method of claim 14 or claim 15, wherein the quantity of limestone corresponds to between 20.1% and 39.9% of the volume of the quantity of hemp oil.

19. A method of preparing the composition of claim 6, comprising:
adding the quantity of metallic drier to the quantity of hemp oil to produce a first solution;
mixing the first solution;
heating the first solution;
adding the quantity of non-ionic emulsifier and the quantity of anionic or non-ionic surfactant to the first solution to produce a second solution;
mixing the second solution;
mixing 25% of the quantity of the water with the quantity of pigment to produce a third solution;
processing the third solution through a mill to produce a slurry;
adding the quantity of thickener and 75% of the quantity of water to the slurry;
adding the slurry to the second solution to produce a final solution; and
mixing the final solution at high speed.

20. The method of claim 19, wherein:
the quantity of hemp oil corresponds to between 16.08% and 31.92% of the volume of the hemp oil-based paint composition;
the quantity of metallic paint drier corresponds to between 6.98% and 13.86% of the volume of the quantity of hemp oil;
the quantity of non-ionic emulsifier corresponds to between 8.34% and 16.63% of the volume of the quantity of hemp oil;
the quantity of anionic or non-ionic surfactant corresponds to between 8.34% and 16.63% of the volume of the quantity of hemp oil;
the quantity of water corresponds to between 83.75% and 221.67% of the volume of the quantity of hemp oil;
the quantity of pigment corresponds to between 69.79% and 138.55% of the volume of the quantity of hemp oil; and/or
the quantity of thickener corresponds to between 10.42% and 52.08% of the volume of the quantity of hemp oil.
